(19) United States
(12) Patent Application Publication
(10) Pub. No.: US 2005/0093995 A1
(43) Pub. Date: May 5, 2005

(54) Video recording method, video recording apparatus, video recording medium, video display method, and video display apparatus

(75) Inventor: Shohei Yoshida, Shimosuwa-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/937,578

(22) Filed: Sep. 10, 2004

(30) Foreign Application Priority Data
Sep. 19, 2003 (JP) 2003-328815
May 26, 2004 (JP) 2004-156530

(51) Int. Cl. H04N 9/73

(52) U.S. Cl. 348/223.1; 386/42; 348/656

(57) ABSTRACT

Aspects of the invention can provide a video recording method that can reduce or prevent occurrence of white compression or flicker at the reproduction of an image in a projection-type video display apparatus using a light valve and a light adjusting device. In the video recording method for recording a video to a video recording medium used in a video display apparatus that changes an image on a light valve in accordance with an input image signal and changes the quantity of light to be incident on the light valve by a light adjusting device, when recording an image signal to the video recording medium, a light adjustment control signal for controlling the light adjusting device can be recorded synchronously with the image signal.

### BACKGROUND OF THE INVENTION

1. Field of Invention

Aspects of the invention can relate to a video recording method, a video recording apparatus, a video recording medium, a video display method, and a video display apparatus, and particularly to a video recording method, a video recording apparatus, a video recording medium, a video display method, and a video display apparatus in which flicker or white compression of an image (also referred to as video in this specification) does not occur when reproducing an image signal recorded on a video recording medium by using a projection-type video display apparatus.

2. Description of Related Art

Related information apparatuses have greatly evolved, and display apparatuses having higher resolution, consuming less power and having reduced thickness have been increasingly demanded. Particularly, liquid crystal display apparatuses are expected to be display apparatuses capable of meeting the above-described demand because alignment of liquid crystal molecules in the liquid crystal display apparatuses can be electrically controlled to change optical characteristics. One form of such related liquid crystal display apparatus is a projection-type video display apparatus (liquid crystal projector), which performs enlarged projection of a video emitted from an optical system onto a screen through a projection lens by using a light valve (liquid crystal light valve or the like) and a light adjusting device for changing the quantity of light to be incident on the light valve.

A related projection-type video display method using a light valve and a light adjusting device can be a display method that enables significant improvement in contrast by fully utilizing a display tonal range (dynamic range) inherent in the light valve. However, in general videos of movie, television and the like, the brightness of the image varies, and it is difficult for the light adjustment state to perfectly follow the changes in the brightness. As a result, problems arise such as occurrence of white compression in the displayed image and flicker of the video.

For example, in an example shown in FIG. 8(a), response of light adjustment control is slow and cannot follow changes in videos, thus causing white compression. In an example shown in FIG. 8(b), response of light adjustment control is too quick and cannot follow changes in videos. Therefore, hunting and flicker of the image can occur.

A related method for expanding the dynamic range of the projection-type display apparatus is disclosed in, for example, JP-A-3-179886.

In this related art, in order to change the quantity of light to be incident on a light modulator (light valve) in accordance with a video signal, the intensity of light output from a lamp (metal halide lamp) as a light source is changed. However, also in the method disclosed, it can be difficult for the light adjustment state to perfectly follow the brightness of the image.

### SUMMARY OF THE INVENTION

Aspects of the invention can provide a video recording method, a video recording apparatus, a video recording medium, a video display method, and a video display apparatus in which flicker or white compression does not occur when reproducing a video recorded on a video recording medium by using a projection-type video display apparatus employing a light valve and a light adjusting device.

An exemplary video recording method according to this invention can be a method for recording a video to a video recording medium used for a video display apparatus that changes an image on a light valve in accordance with an input image signal and changes the quantity of light to be incident on the light valve by a light adjusting device. The video recording method being characterized in that when recording an image signal to the video recording medium, a light adjustment control signal for controlling the light adjusting device is recorded synchronously with the image signal.

In such a method, together with and synchronously with an image signal, information on the brightness of the image (for example, maximum value or average value of gradation of brightness of the image) is recorded in advance as a light adjustment control signal to a recording medium, such as DVD-ROM. Then, when a video display apparatus having a light valve and a light adjusting device reproduces the image signal from the video recording medium, the quantity of light adjustment by the light adjusting device is controlled synchronously with the image by the light adjustment control signal recorded on the video recording medium.

Thus, the image signal and the light adjustment control signal can be recorded in association with each other to the video recording medium in advance. Therefore, when reproducing the video signal from the video recording medium, the image signal and the quantity of light adjustment by the light adjusting device can be prevented from becoming asynchronous, and occurrence of white compression or flicker in the reproduced video can be prevented. Moreover, the light adjustment control signal enables reproduction of the video in a light quantity state intended by the video producer.

The video recording method according to this invention is also characterized in that the light adjustment control signal is a signal representing information on the quantity of light adjustment, brightness of image, or quantity of exposure at the time of recording.

In such a method, the quantity of light adjustment (quantity of dimming), the brightness of image, or the brightness (quantity of exposure) at the time of recording is selected as the light adjustment control signal recorded onto the video recording medium, in accordance with the requirements.

Thus, the type of the light adjustment control signal can be selected in accordance with the shooting circumstances. Moreover, with the video director's intention, the video can be reproduced with the light adjustment control signal of the optimum type selected in accordance with the video.

The video recording method according to this invention is also characterized in that the light adjustment control signal is recorded for each color of R, G and B or commonly to these colors R, G and B. In such a method, when recording the light adjustment control signal to the video recording medium, whether the light adjustment control signal is recorded for each color of R (red), G (green) and B (blue) or the light adjustment control signal common to these colors is recorded is selected and recorded. Thus, a video recording medium corresponding to a video display apparatus that controls the quantity of light adjustment for each color of R (red), G (green) and B (blue) can be produced, and a video recording medium corresponding to a video display apparatus that controls the quantity of light commonly to these colors can also be produced, when necessary.

The video recording method according to this invention can also be characterized in that the light adjustment control signal to be recorded includes white balance information. Thus, in the video display apparatus, after shooting light source color information representing the color of light source at the movie-shooting is acquired on the basis of the white balance information, light source correction information for canceling and correcting the shooting light source color information to reference point color information representing reference color information is calculated, and on the basis of the correction light source information, the quantity of light can be controlled by the light adjusting device synchronously with the image signal to be reproduced.

A video recording apparatus according to this invention can be a video recording apparatus for recording an image signal to a video recording medium used for a video display apparatus that changes an image on a light valve in accordance with an input image signal and changes the quantity of light to be incident on the light valve by a light adjusting device. The video recording apparatus can be characterized by having a unit for, when recording an image signal to the video recording medium, recording a light adjustment control signal for controlling the light adjusting device synchronously with the image signal.

With such a structure, when recording an image signal to a recording medium, such as DVD-ROM, the video recording apparatus records information on the brightness of the image (for example, maximum value or average value of gradation of brightness of the image) as a light adjustment control signal synchronously with the image signal. Then, when a video display apparatus having a light valve and a light adjusting device such as a projection-type video display apparatus reproduces the image signal from the video recording medium, the quantity of light adjustment by the light adjusting device is controlled synchronously with the image by the light adjustment control signal recorded on the video recording medium.

Thus, the image signal and the light adjustment control signal can be recorded in association with each other to the video recording medium in advance. Therefore, when the video display apparatus reproduces the video from the video recording medium, the video and the quantity of light adjustment can be prevented from becoming asynchronous, and occurrence of white compression or flicker in the reproduced video can be prevented. Moreover, the light adjustment control signal enables reproduction of the video in a light quantity state intended by the video producer.

The exemplary video recording apparatus according to this invention can also be characterized in that the light adjustment control signal is a signal representing information on the quantity of light adjustment, brightness of image, or quantity of exposure at the movie-shooting. With such a structure, the quantity of light adjustment (quantity of dimming), the brightness of image, or the brightness (quantity of exposure) at the time of recording is selected as the light adjustment control signal recorded onto the video recording medium, in accordance with the requirements. Thus, the type of the light adjustment control signal can be selected in accordance with the shooting site and circumstances. Moreover, with the video director's intention, the video can be reproduced with the light adjustment control signal of the optimum type selected in accordance with the video.

The video recording apparatus according to this invention can also be characterized in that the light adjustment control signal is recorded for each color of R, G and B or commonly to these colors R, G and B. With such a structure, when recording the light adjustment control signal to the video recording medium, whether the light adjustment control signal is recorded for each color of R (red), G (green) and B (blue) or the light adjustment control signal common to these colors is recorded is selected and recorded. Thus, a video recording medium corresponding to a video display apparatus that controls the quantity of light adjustment for each color of R (red), G (green) and B (blue) can be produced, and a video recording medium corresponding to a video display apparatus that controls the quantity of light adjustment commonly to these colors can also be produced, when necessary.

The video recording apparatus according to this invention can also be characterized in that the light adjustment control signal to be recorded includes white balance information. Thus, in the video display apparatus, after shooting light source color information representing the color of light source at the time of recording is acquired on the basis of the white balance information, correction light source information for canceling and correcting the shooting light source color information to reference point color information representing reference color information is calculated, and on the basis of the correction light source information, the quantity of light can be controlled by the light adjusting device synchronously with the image signal to be reproduced.

A video recording medium according to this invention is a video recording medium to be reproduced by a video display apparatus that changes an image on a light valve in accordance with an input image signal and changes the quantity of light to be incident on the light valve by a light adjusting device. The video recording medium having a light adjustment control signal for controlling the light adjusting device that is recorded therein together with and synchronously with the image signal. With such a structure, information on the brightness of the image (for example, maximum value or average value of gradation of brightness of the image) is recorded as a light adjustment control signal to a video recording medium such as DVD-ROM synchronously with the image signal. Then, when a video display apparatus having a light valve and a light adjusting device reproduces the image signal from this video recording medium, the quantity of light adjustment is controlled by the light adjusting device synchronously with the image by the light adjustment control signal recorded on the video recording medium. Thus, the image signal and the light adjustment control signal can be recorded in association with each other to the video recording medium in advance. Therefore, when the video display apparatus reproduces the video from the video recording medium, the video and the quantity of light adjustment can be prevented from changing asynchronously, and occurrence of white compression or flicker in the reproduced video can be prevented. Moreover, the light adjustment control signal enables reproduction of the video in a light quantity state intended by the video producer.

The video recording medium according to this invention can also be characterized in that the light adjustment control signal is a signal representing information on the quantity of light adjustment, brightness of image, or quantity of exposure at the movie-shooting. With such a structure, the quantity of light adjustment (quantity of dimming), the brightness of image, or the brightness (quantity of exposure) at the movie-shooting is selected as the light adjustment control signal recorded onto the video recording medium, in accordance with the requirements. Thus, the type of the light adjustment control signal can be selected in accordance with the shooting site and circumstances. Moreover, with the video director's intention, the video can be reproduced with the light adjustment control signal of the optimum type selected in accordance with the video.

The video recording medium according to this invention is also characterized in that the light adjustment control signal is recorded for each color of R, G and B or commonly to these colors R, G and B. With such a structure, when recording the light adjustment control signal to the video recording medium, whether the light adjustment control signal is recorded for each color of R (red), G (green) and B (blue) or the light adjustment control signal common to these colors is recorded is selected and recorded. Thus, a video recording medium corresponding to a video display apparatus that controls the quantity of light adjustment for each color of R (red), G (green) and B (blue) can be produced, and a video recording medium corresponding to a video display apparatus that controls the quantity of light adjustment commonly to these colors can also be produced, when necessary.

The video recording medium according to this invention is also characterized in that the light adjustment control signal to be recorded includes white balance information. Thus, in the video display apparatus, after shooting light source color information representing the color of light source at the movie-shooting is acquired on the basis of the white balance information, light source correction information for canceling and correcting the shooting light source color information to reference point color information representing reference color information is calculated, and on the basis of the correction light source information, the quantity of light can be controlled by the light adjusting device synchronously with the image signal to be reproduced.

An exemplary video display method according to this invention is a video display method in a video display apparatus that changes an image on a light valve in accordance with an input image signal and changes the quantity of light to be incident on the light valve by a light adjusting device. The video display method can include reading an image signal and a light adjustment control signal for controlling the light adjusting device from a video recording medium, and when reproducing the image signal, controlling the quantity of light by the light adjusting device synchronously with the image signal to be reproduced, on the basis of the light adjustment control signal.

In such a method, when reproducing the image signal recorded on the video recording medium, the video display apparatus reads out the light adjustment control signal recorded in advance in association with the image signal and controls the quantity of light adjustment by the light adjusting device synchronously with the image signal to be reproduced, on the basis of the light adjustment control signal. Thus, when the video display apparatus reproduces the image signal, the video and the quantity of light adjustment can be prevented from becoming asynchronous, and occurrence of white compression or flicker in the reproduced video can be prevented.

The video display method according to this invention is also characterized in that the light adjustment control signal can include white balance information, and that after shooting light source color information representing the color of light source at the movie-shooting is acquired on the basis of the white balance information, correction light source information for canceling and correcting the shooting light source color information to reference point color information representing reference color information is calculated, and on the basis of the correction light source information, the quantity of light of the light adjusting device is controlled synchronously with the image signal to be reproduced. Thus, for example, if the color of the shot video becomes greenish shot, the color of light source is corrected to magenta color on the basis of the correction light source information. Therefore, the color perceived at the time of actual shooting can be realized faithfully.

The video display method according to this invention is also characterized in that a medium from which the image signal is read and a medium from which the light adjustment control signal is read are of different types. In such a method, for example, the image signal can be taken from a video recording medium such as DVD-ROM and the light adjustment control signal can be read through the Internet or the like. Thus, only the image signal is recorded to the video recording medium, such as DVD-VIDEO, as in the conventional technique, so that even a conventional video display apparatus (video display apparatus that does not read the light adjustment control signal) can reproduce the image signal. Moreover, provision of the light adjustment control signal (distribution via the Internet or the like) can be separately managed and it can be provided as an optional service.

An exemplary video display apparatus according to this invention is a video display apparatus that changes an image on a light valve in accordance with an input image signal and changes the quantity of light to be incident on the light valve by a light adjusting device, the video display apparatus being can include a unit for reading an image signal and a light adjustment control signal for controlling the light adjusting device from a video recording medium, and a unit for, when reproducing the image signal, controlling the quantity of light of the light adjusting device synchronously with the image signal to be reproduced, on the basis of the light adjustment control signal.

With such a structure, when reproducing the image signal recorded on the video recording medium, the video display apparatus reads out the light adjustment control signal recorded in advance in association with the image signal and controls the quantity of light adjustment by the light adjusting device synchronously with the image signal to be reproduced, on the basis of the light adjustment control signal. Thus, when the video display apparatus reproduces the image signal, the video and the quantity of light adjustment can be prevented from changing asynchronously, and occurrence of white compression or flicker in the reproduced video can be prevented.

The video display apparatus according to this invention can also be characterized in that the light adjustment control signal includes white balance information, and that the unit for controlling the quantity of light of the light adjusting device acquires shooting light source color information representing the color of light source at the movie-shooting on the basis of the white balance information, then calculates correction light source information for canceling and correcting the shooting light source color information to reference point color information representing reference color information, and controls the quantity of light of the light adjusting device synchronously with the image signal to be reproduced, on the basis of the correction light source information.

Thus, for example, when the color of the video shot at the movie-shooting becomes greenish, the color of light source is corrected to magenta color on the basis of the correction light source information. Therefore, the color perceived at the time of actual shooting can be realized faithfully.

The video display apparatus according to this invention can also be characterized in that a medium from which the image signal is read and a medium from which the light adjustment control signal is read are of different types. With such a structure, for example, the image signal can be taken from a video recording medium, such as DVD-VIDEO, and the light adjustment control signal can be read via the Internet or the like. Thus, only the image signal is recorded to the video recording medium, such as DVD-VIDEO, as in the conventional technique, so that even a conventional video display apparatus (video display apparatus that does not read the light adjustment control signal) can reproduce the image signal. Moreover, provision of the light adjustment control signal (distribution via the Internet or the like) can be separately managed and it can be provided as an optional service.

### BRIEF DESCRIPTION OF THE DRAWINGS

The invention will be described with reference to the accompanying drawings, wherein like numerals reference like elements, and wherein:

FIG. 1 is a schematic structural view of a display unit of a projection-type video display apparatus;

FIG. 2 is a view showing a first exemplary structure of a video display apparatus;

FIG. 3 is a view showing a second exemplary structure of the video display apparatus;

FIG. 4 is a view for explaining a video recording apparatus;

FIG. 5 is a view showing a first exemplary structure of the video recording apparatus;

FIG. 6 is a view showing a second exemplary structure of the video recording apparatus;

FIG. 7 is a view showing a third exemplary structure of the video recording apparatus;

FIG. 8 is a view for explaining white compression and flicker of an image; and

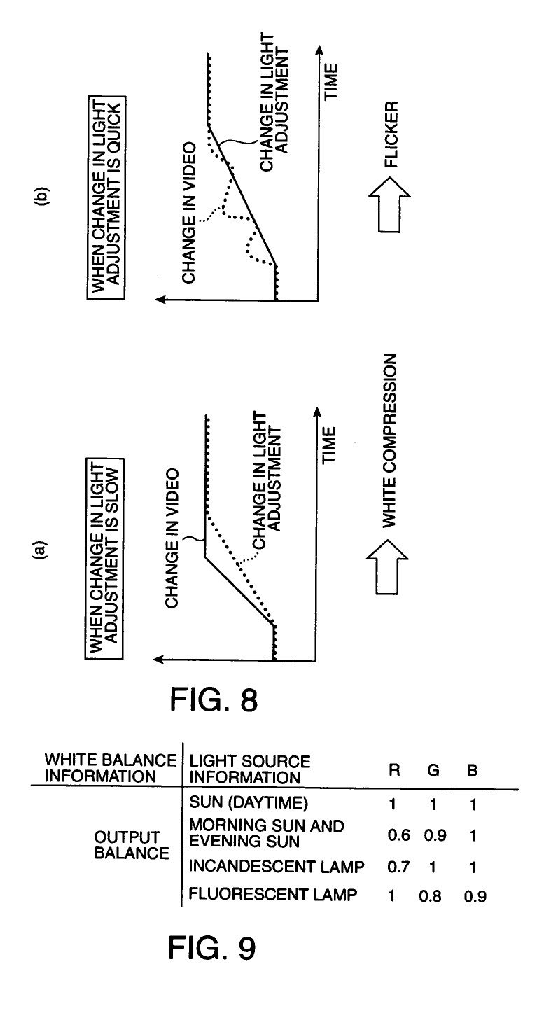

FIG. 9 is a view showing the relation between white balance information and output balance.

### DETAILED DESCRIPTION OF PREFERRED EMBODIMENTS

Exemplary embodiments for carrying out this invention will now be described with reference to the drawings.

First, an exemplary video display apparatus according to this invention will be described.

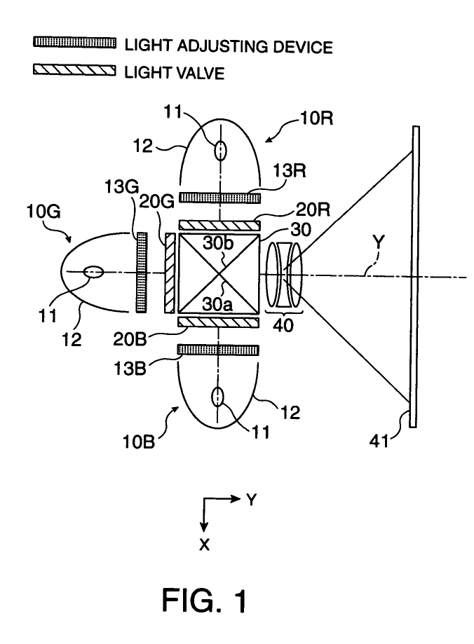

FIG. 1 shows a display unit of a projection-type video display apparatus to which this invention is applied. It is an example of three-plate projection-type color video display apparatus having light valves (liquid crystal light valves or the like) that transmit different colors such as R (red), G (green) and B (blue), respectively. In FIG. 1, numerals 10R, 10G, 10B denote light sources, 13R, 13G, 13B denote light adjusting devices, 20R, 20G, 20B denote light valves (liquid crystal light valves), 30 denotes a cross dichroic prism, 40 denotes a projection lens, and 41 denotes a screen.

The light sources 10R, 10G, 10B are color light sources capable of emitting red light, green light, and blue light, respectively. Each of the light sources 10R, 10G, 10B is formed by a light-emitting unit 11 such as a light-emitting diode (LED) organic electroluminescence device (organic EL device) or inorganic electroluminescence device (inorganic EL device), and a reflector 12 that reflects output light of the light-emitting unit 11. The light valves 20R, 20G, 20B are provided corresponding to the light sources 10R, 10G, 10B, respectively, and are capable of performing light modulation for the corresponding light sources.

Each of the light adjusting devices 13R, 13G, 13B are schematically formed by polarizing plates that are stacked on both sides of a liquid crystal panel formed by a pair of glass substrates (optically transparent substrates) with a liquid crystal layer held between them. As the liquid crystal held between the pair of glass substrates, a liquid crystal having a high response speed, such as FLC is used.

When receiving a driving signal from a light adjusting device driver and applying a voltage to an optically transparent electrode, the light adjusting device 13R, 13G, 13B can freely change distribution of the highest (100%) transmittance period and the lowest (0%) transmittance period by changing the period of no voltage applied and the period of voltage applied in a frame. As the distribution of the time when the transmittance is 100% and the time when the transmittance is 0% is thus changed, the quantity of transmissive light during one frame can be changed by the light adjusting devices 13R, 13G, 13B. Therefore, for a bright image, the distribution of the time when the transmittance is 100% in one frame is increased while the distribution of the time when the transmittance is 0% is reduced, thus increasing the quantity of light during one frame.

For a dark image, the distribution of the time when the transmittance is 100% in one frame is reduced while the distribution of the time when the transmittance is 0% is increased, thus reducing the quantity of light. Thus, the quantity of emitted light during one frame from the light-emitting units 11 (quantity of light emitted from the light-emitting units 11 during one frame) is adjusted by the light adjusting devices 13R, 13G, 13B.

The cross dichroic prism 30 has a structure formed by bonding four right-angled prisms, and on their bonding surfaces 30a, 30b, a light reflecting film (not shown) made of a dichroic multilayer film is formed in a cross shape. Specifically, on the bonding surface 30a, a light reflecting film that reflects red image light formed by the light valve 20R and transmits green and blue image light formed by the light valves 20G, 20B is provided. On the other hand, on the bonding surface 30b, a light reflecting film that reflects blue image light formed by the light valve 20B and transmits red and green image light formed by the light valves 20R, 20G is provided. These light reflecting films combine video light of each color formed by the light valves 20R to 20B, thus forming light representing a color image. The combined light is projected on the screen 41 by the projection lens 40, which is a projection optical system, and an enlarged image is displayed.

Next, an exemplary circuit structure of the video display apparatus according to this invention will be described.

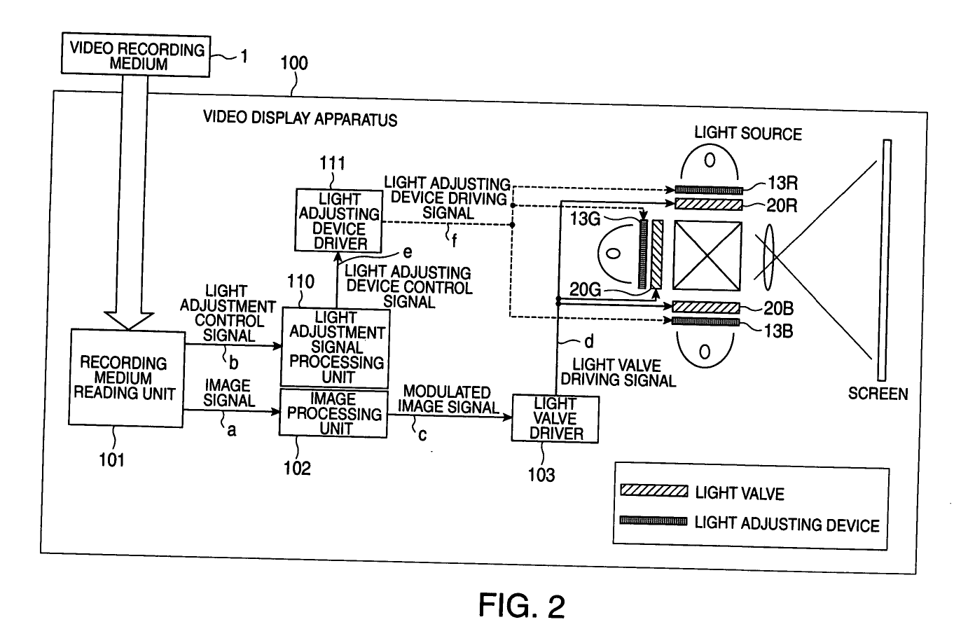

FIG. 2 is a view showing a first exemplary structure of the video display apparatus according to this invention. Reference numeral 1 denotes a video recording medium (CD-ROM, DVD-ROM, or the like) on which an image signal and a light adjustment control signal have been recorded. Reference numeral 100 denotes a video display apparatus. Reference numeral 101 denotes a recording medium reading unit for reading the “image signal” and “light adjustment control signal” recorded on the video recording medium. Reference numeral 102 denotes an image processing unit for performing expansion processing of the image signal. Reference numeral 103 denotes a light valve driver for driving the light valves. Reference numeral 110 denotes a light adjustment signal processing unit for generating a signal to drive a light adjusting device driver on the basis of the light adjustment control signal and white balance information included in the light adjustment control signal. Reference numeral 111 denotes a light adjusting device driver. The light valve driver 103 and the light adjusting device driver 111 have a function of driving the light valve and the light adjusting device for each of the difference colors R (red), G (green) and B (blue).

The video recording medium 1, such as DVD-ROM and CD-ROM, is inserted into the recording medium reading unit 101, and the image signal and light adjustment control signal (signal synchronized with the frame of the image signal recorded on the video recording medium 1 are read by the recording medium reading unit 101. As this light adjustment control signal, control information on the quantity of light adjustment for each of the different colors R (red), G (green) and B (blue) is usually recorded, but control information on the quantity of light adjustment common to R (red), G (green) and B (blue) may be recorded.

The image signal a and the light adjustment control signal b, read by the recording medium reading unit 101, are outputted to the image processing unit 102. The light adjustment control signal b is also outputted to the light adjustment control signal processing unit 110. The image processing unit 102 performs image processing, such as expansion processing to set the quantity of expansion of the video signal of each color, of the image signal a inputted from the recording medium reading unit 101, and outputs a modulated image signal c to the light valve driver 103. At this point, information indicating the brightness acquired from the light adjustment signal b is also outputted to the light valve driver 103. The light valve driver 103 generates a light valve driving signal d on the basis of the modulated image signal c and the information indicating the brightness inputted from image processing unit 102, thus driving the light valves 20R, 20G, 20B.

The light adjustment signal processing unit 110 can generate and output a light adjusting device control signal e for driving the light adjusting device driver 111, on the basis of the light adjustment control signal b inputted from the recording medium reading unit 101. The processing by the light adjustment signal processing unit 110 in generating the light adjusting device control signal e will now be described.

First, the light adjustment signal processing unit 110 acquires shooting light source color information such as color temperature and Δuv value of the light source at the movie-shooting, from the white balance information. This shooting light source color information is compared with reference point (D65 or the like) color information, and correction light source color information for creating the color of the reference point color information by mixing with the shooting light source color (i.e., with this correction light source information, the shooting light source color information is canceled and the reference point color information is outputted) is found by arithmetic operation or LUT. Next, on the basis of the correction light source color information, output balance of R, G, B that enables output of the correction light source color is found by arithmetic operation or LUT, and as the product of this output balance and the light adjustment control signal b, the light adjusting device control signal e with the adjusted output balance is acquired.

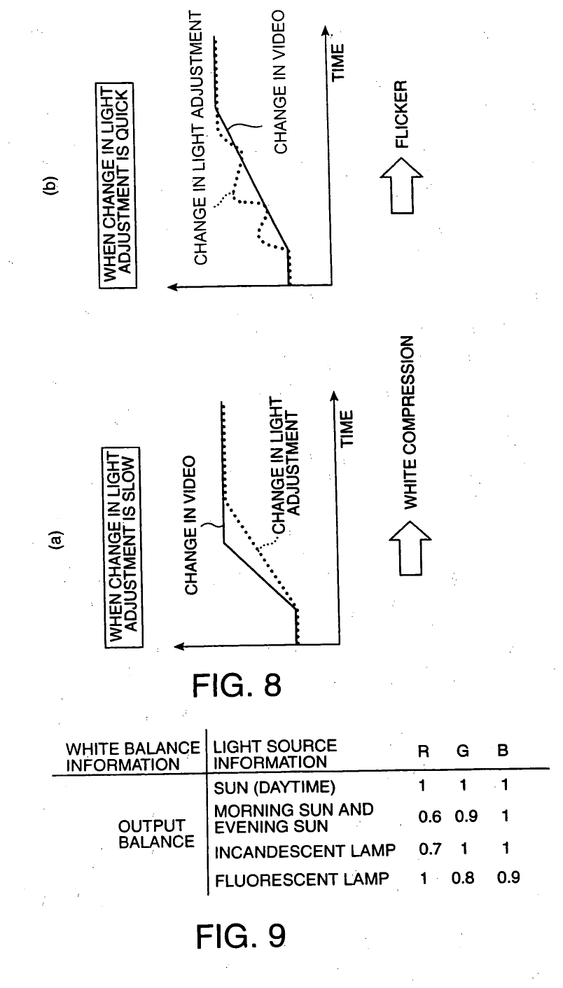

It is also possible to provide the relation between white the balance information and the output balance in LUT, as in LUT shown in FIG. 9, and to acquire the light adjusting device control signal e with the adjusted output balance from the output balance and the light adjustment control signal b. As such processing is performed, for example, when the color of a shot video becomes greenish at the movie-shooting, the color perceived at the movie-shooting can be faithfully reproduced by using a light source of magenta color.

Then, the light adjusting device driver 111 generates a light adjusting device driving signal f on the basis of the light adjusting device control signal e inputted from the light adjustment signal processing unit 110, thus drives the light adjusting devices 13R, 13G, 13B, and controls the quantity of light to be incident on the light valves 20R, 20G, 20B.

As the contents of the light adjustment control signal recorded on the video recording medium 1, various information, such as information on the quantity of light adjustment (quantity of dimming), information on the brightness of image, or information on the quantity of exposure at the movie-shooting (determined by environmental elements at the movie-shooting, such as shutter speed, aperture, and sensitivity of image pickup device) can be used. That is, the light adjustment control signal b may be information that can properly control the quantity of light adjustment by the light adjusting devices 13R, 13G, 13B in accordance with images on the side of the video display apparatus 100.

In this manner, in the video display apparatus according to this invention, when reproducing an image signal recorded on a video recording medium, a light adjustment control signal recorded in advance in association with the image signal can be read out simultaneously and the quantity of light adjustment can be properly controlled synchronously with the reproduced image on the basis of the light adjustment control signal. Thus, when the video display apparatus reproduced the image signal, the reproduced video and the quantity of light adjustment can be prevented from becoming asynchronous and occurrence of white compression or flicker in the video can be prevented.

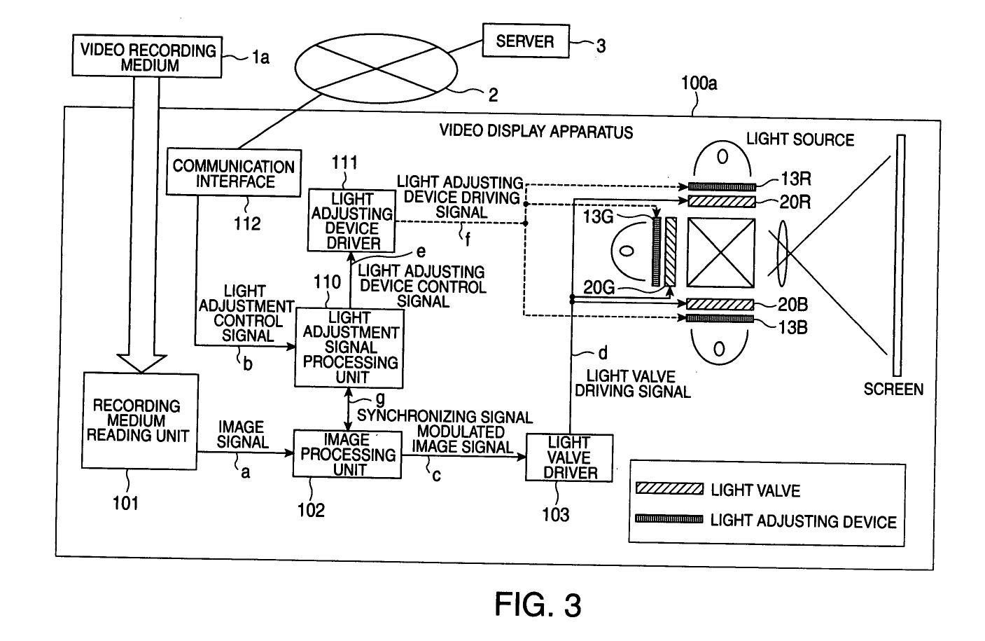

FIG. 3 is a view showing a second exemplary structure of the video display apparatus according to this invention. It shows an example of taking an image signal and a light adjustment control signal from media of different types, respectively. That is, it shows an example in which a video recording medium 1a is a DVD-ROM or the like having only an image signal recorded thereon while a light adjustment control signal b is taken from an external server 3 via a communication interface 112 and a communication network (Internet or the like) 2. In this case, the processing at the light adjustment signal processing unit 110 and the processing at the image processing unit 102 are performed synchronously by using a synchronizing signal g, and the image signal a and the light adjustment control signal b are synchronized.

In the example shown in FIG. 3, the image signal is recorded onto the video recording medium 1a and the light adjustment control signal b is read from the external server 3. However, contrary to this, it is also possible to record the light adjustment control signal b to the recording medium 1a and read the image signal a from the external server 3.

In this manner, as media of different types are used for the medium from which the image signal is taken and the medium from which the light adjustment control signal is taken, for example, it is possible to read the image signal from a video recording medium such as DVD-ROM and to read the light adjustment control signal through the Internet or the like. Thus, only the image signal is recorded to the video recording medium, such as DVD-ROM, as in the conventional technique, so that even a conventional video display apparatus (video display apparatus that does not have a function of reading the light adjustment control signal) can reproduce the image signal. Moreover, distribution of the light adjustment control signal can be separately managed and it can be provided as an optional service.

In the exemplary structures shown in FIGS. 2 and 3, the quantity of light to be incident on the light valves 20R, 20G, 20B from the light-emitting unit 11 is controlled using the light adjusting devices 13R, 13G, 13B. However, it should be understood that this invention is not limited to these structures. To control the quantity of light incident on the light valves 20R, 20G, 20B, any combination of a light source for outputting a predetermined quantity of light and a filter for limiting the quantity of light transmittance per unit time may be used. For example, a diaphragm mechanism, a time-division shutter, a liquid crystal shutter or the like can be used. Moreover, the quantity of output light of the light source may be directly controlled.

As the light valves, digital mirror devices (also referred to as DMD) as well as liquid crystal light valves may be used. Moreover, the technical idea used in the video display apparatus according to this invention is not limited to the projection-type video display apparatus and can also be applied to a video display apparatus using a direct-view display.

An exemplary video recording apparatus according to this invention will now be described.

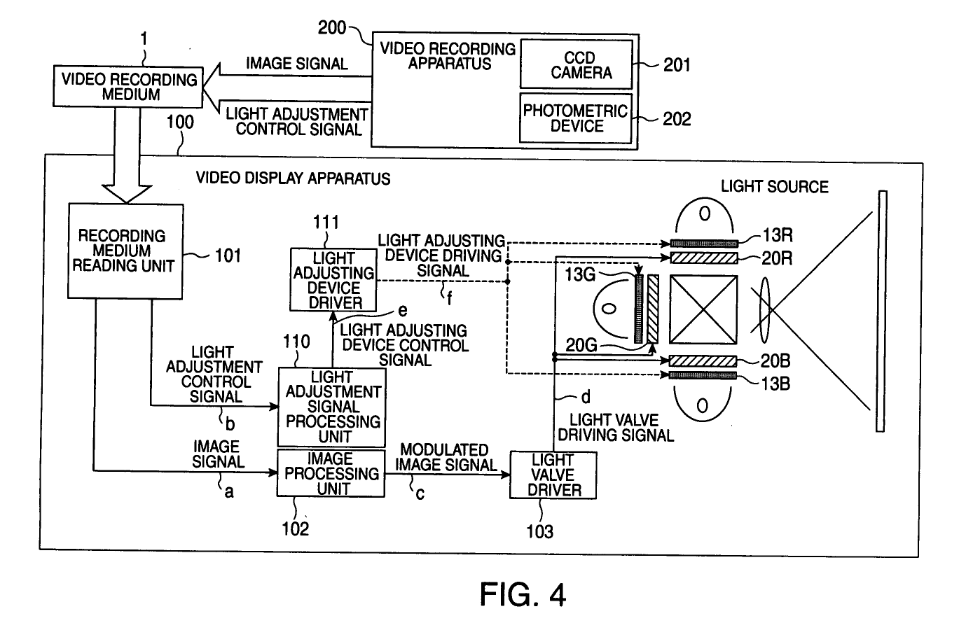

FIG. 4 is a view for explaining a video recording apparatus according to this invention. In a video recording apparatus 200, when shooting a video by a CCD camera unit 201, the brightness (quantity of exposure) at the shooting site is measured by a photometric device 202, and an image signal acquired from the CCD camera unit 201 and a light adjustment control signal generated on the basis of the measurement data from the photometric device 202 are recorded onto a video recording medium 1. The light adjustment control signal is recorded synchronously with frames (image frames) in the image signal.

In this manner, as the image signal and the light adjustment control signal are recorded in advance in association with each other onto the video recording medium 1, when the video display apparatus reproduced the video, the image and the quantity of light adjustment can be prevented from being asynchronous and occurrence of white compression or flicker in the reproduced video can be prevented. Moreover, the light adjustment control signal enables reproduction of the video in a light quantity state intended by the video producer.

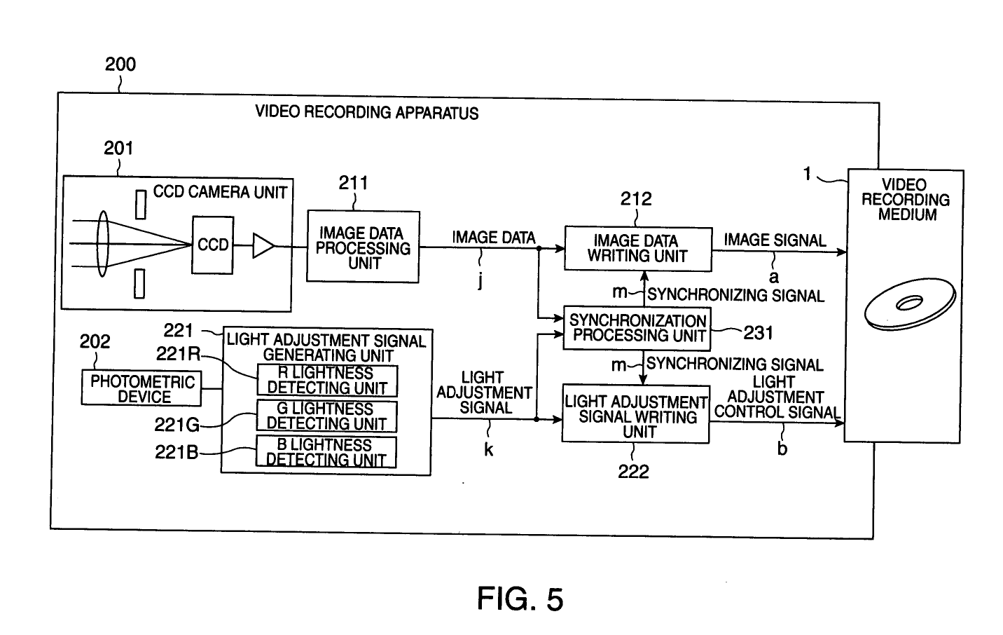

FIG. 5 is a view showing a first exemplary structure of the video recording apparatus according to this invention. Reference numeral 201 denotes a CCD camera unit. Reference numeral 202 denotes a photometric device. Reference numeral 211 denotes an image data processing unit. Reference numeral 212 denotes an image data writing unit. Reference numeral 221 denotes a light adjustment signal generating unit. Reference numeral 222 denotes a light adjustment signal writing unit. Reference numeral 231 denotes a synchronization processing unit.

The CCD camera unit 201 is a video camera for color shooting that has an optical system and a CCD image pickup device. Image pickup data shot by the CCD camera unit 201 is outputted to the image data processing unit 211. The image data processing unit 211 digitizes the image pickup data received from the CCD camera unit 201 and performs image data compression processing or the like to prepare image data.

The image data writing unit 212 receives image data j prepared by the image data processing unit 211, then generates an image signal a of a predetermined recording format (for example, MPEG or the like) from the image data j, and writes the image signal a to the video recording medium 1.

On the other hand, the photometric device 202 has a function of monitoring the brightness (quantity of exposure) of the surroundings of the shooting site where shooting is carried out by the CCD camera unit 201. Data measured by the photometric device 202 is inputted to the light adjustment signal generating unit 221, where the brightness of each color of R (red), G (green) and B (blue) is detected by a R (red) lightness detecting unit 221R, a G (green) lightness detecting unit 221G and a B (blue) lightness detecting unit 22 1B, and a light adjustment signal k for controlling the light adjusting devices (see light adjusting devices 13R, 13G, 13B shown in FIG. 2) corresponding to the individual colors in the video display apparatus is generated. The light adjustment signal k generated by the light adjustment signal generating unit 221 is outputted to the light adjustment signal writing unit 222. The light adjustment signal writing unit 222 generates a light adjustment control signal b on the basis of the light adjustment signal k inputted from the light adjustment signal generating unit 221 and writes the light adjustment control signal b to the video recording medium 1. The light adjustment control signal b includes white balance information.

The synchronization processing unit 231 generates a synchronizing signal m on the basis of the image data j and the light adjustment signal k. This synchronizing signal m is sent to the image data writing unit 212 and the light adjustment signal writing unit 222, and the writing of the light adjustment control signal b to the video recording medium 1 is synchronized with the image signal a.

The light adjustment control signal b is usually written to the video recording medium 1 for each color of R (red), G (green) and B (blue). Alternatively, the light adjustment control signal b common to these colors is written, when necessary.

As the contents of the light adjustment control signal recorded onto the video recording medium 1, various information, such as information on the quantity of light adjustment (quantity of dimming), information on the brightness of image, and information on the quantity of exposure at the movie-shooting can be used. In other words, the light adjustment control signal b may be information that can properly control the quantity of light adjustment by the light adjusting devices 13R, 13G, 13B in accordance with images on the side of the video display apparatus 100.

In this manner, as the image signal at the time of recording and the light adjustment control signal based on the brightness of the surrounding at the movie-shooting are associated (synchronized) with each other and thus recorded to the video recording medium 1, when the video display apparatus reproduces the video, the image and the quantity of light adjustment can be prevented from becoming asynchronous and occurrence of white compression or flicker in the video can be prevented. Moreover, the light adjustment control signal enables reproduction of the video in a light quantity control state as intended by the video producer. The light adjustment control signal can be automatically recorded.

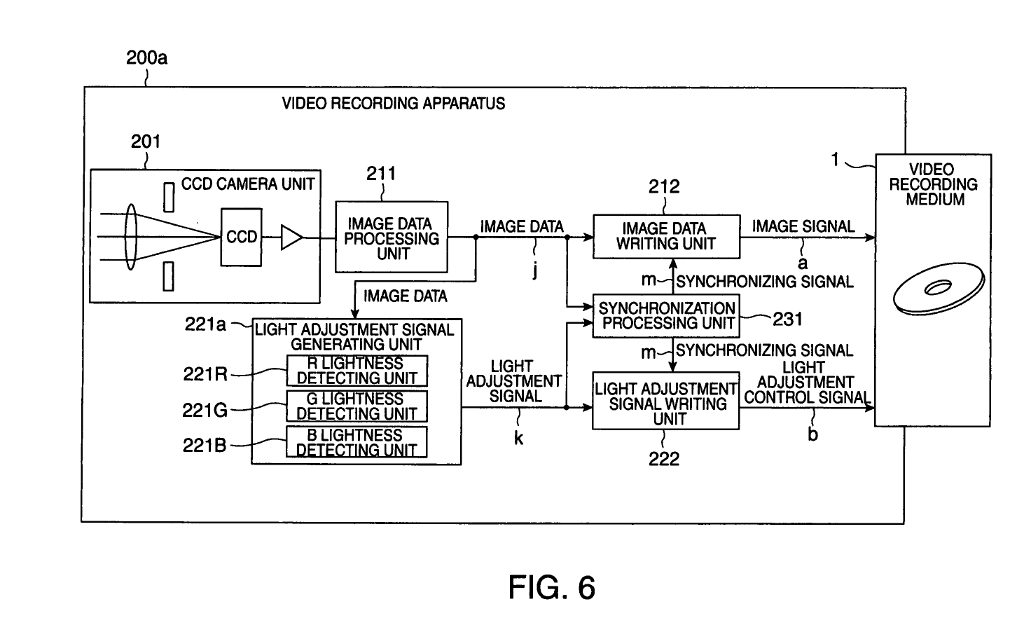

FIG. 6 is a view showing a second exemplary structure of the video recording apparatus according to this invention. In a video recording apparatus 200a, the photometric device 202 shown in FIG. 5 is not used and a light adjustment signal is directly acquired from image data. A light adjustment signal generating unit 221a in the video recording apparatus 200a acquires image data j from the image data processing unit 211 and generates a light adjustment signal k from gradation of brightness (for example, maximum value, average value or the like) in this image data. The light adjustment signal writing unit 222 generates a light adjustment control signal b on the basis of the light adjustment signal k and writes the light adjustment control signal b to the video recording medium 1.

In this example, the photometric device 202 can be omitted, and the light adjustment control signal b can be generated on the basis of the image data j and can be recorded to the video recording medium 1.

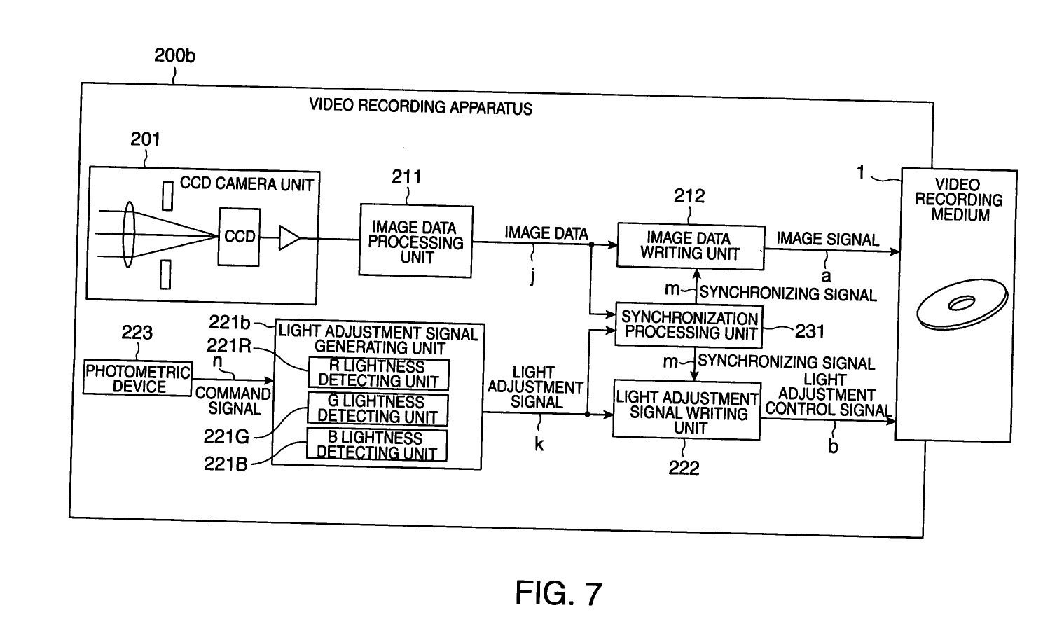

FIG. 7 is a view showing a third exemplary structure of the video recording apparatus according to this invention. In a video recording apparatus 200b, the photometric device 202 shown in FIG. 5 is not used and a light adjustment signal is manually set by a manual light adjustment quantity setting unit 223. A light adjustment signal generating unit 221b in the video recording apparatus 200b acquires a command signal n for the quantity of light adjustment from the manual light adjustment quantity setting unit 223 and generates a light adjustment signal k on the basis of this command signal n. The light adjustment signal writing unit 222 generates a light adjustment control signal b on the basis of the light adjustment signal k and writes the light adjustment control signal b to the video recording medium 1.

The manual setting of the light adjustment signal need not be synchronous with the shooting. The user can set the quantity of light adjustment when reproducing the shot video.

In this example, the photometric device 202 can be omitted and the light adjustment control signal b can be manually prepared as intended by the video producer.

The exemplary embodiments of this invention are described above. The function of each processing unit in the video display apparatuses shown in FIGS. 2 and 3 and of each processing unit in the video recording apparatuses shown in FIGS. 5 to 7 may be achieved by dedicated hardware. Alternatively, a program for realizing the function of each processing unit may be recorded onto a computer-readable recording medium, and the program recorded on the recording medium may be read and executed by a computer system, thus performing necessary processing for each processing unit in the video display apparatuses shown in FIGS. 2 and 3 and each processing unit in the video recording apparatuses shown in FIGS. 5 to 7. Here, the term computer system includes the operating system and hardware, such as peripheral devices.

The term computer-readable recording medium can refer to a portable medium, such as a flexible disk, magneto-optical disc, ROM, or CD-ROM, or a recording device, such as a hard disk arranged in a computer system. The term computer-readable recording medium also can include a medium that dynamically holds a program for a short period of time (transmission medium or transmission wave), such as a communication channel in the case of sending the program via a network like the Internet or via a communication line like a telephone line, and a medium that holds the program for a predetermined time, such as a volatile memory in a computer system to be a server or client in this case. The program may be a program for realizing a part of the above-described function or may be a program that can realize the above-described function in combination with a program already recorded in the computer system, that is, a so-called differential file (differential program).

Although the exemplary embodiments of this invention are described above, it should be understood that the video display apparatus and the video recording apparatus according to this invention are not limited to the above-described examples shown in the drawings and it is a matter of course that various changes can be added thereto without departing from the scope of this invention.

According to this invention, together with an image signal, a light adjustment control signal corresponding to the image signal is recorded in advance to a video recording medium, thus enabling reproduction of the image without causing flicker or white compression at the time of reproducing the image and without causing a viewer to feel the image unnatural or unfit. Therefore, this invention can be applied to a video recording method, a video recording apparatus, a video recording medium, a video display method, a video display apparatus and the like.

1. A video recording method for recording a video to a video recording medium used for a video display apparatus that changes an image on a light valve in accordance with an input image signal and changes a quantity of light to be incident on the light valve by a light adjusting device, the video recording method comprising:
when recording an image signal to the video recording medium, a light adjustment control signal that controls the light adjusting device being recorded synchronously with the image signal.

2. The video recording method as claimed in claim 1, the light adjustment control signal being a signal representing information on a quantity of light adjustment, brightness of image, or quantity of exposure at a time of recording the video.

3. The video recording method as claimed in claim 1, the light adjustment control signal being recorded for each color of R, G and B or commonly to the colors R, G and B.

4. The video recording method as claimed in claim 1, the light adjustment control signal including white balance information.

5. A video recording apparatus for recording an image signal to a video recording medium used for a video display apparatus that changes an image on a light valve in accordance with an input image signal and changes a quantity of light to be incident on the light valve by a light adjusting device,
the video recording apparatus comprising a unit that when recording an image signal to the video recording medium, records a light adjustment control signal that controls the light adjusting device synchronously with the image signal.

6. The video recording apparatus as claimed in claim 5, the light adjustment control signal being a signal representing information on a quantity of light adjustment, brightness of image, or quantity of exposure at a time of recording the video.

7. The video recording apparatus as claimed in claim 5, the light adjustment control signal being recorded for each color of R, G and B or commonly to the colors R, G and B.

8. The video recording apparatus as claimed in claim 5, the light adjustment control signal including white balance information.

9. A video recording medium to be reproduced by a video display apparatus that changes an image on a light valve in accordance with an input image signal and changes a quantity of light to be incident on the light valve by a light adjusting device, the video recording medium comprising:
a light adjustment control signal that controls the light adjusting device being recorded therein together with and synchronously with the image signal.

10. The video recording medium as claimed in claim 9, the light adjustment control signal being a signal representing information on a quantity of light adjustment, brightness of image, or quantity of exposure at a time of recording the video.

11. The video recording medium as claimed in claim 9, the light adjustment control signal being recorded for each color of R, G and B or commonly to the colors R, G and B.

12. The video recording medium as claimed in claim 9, the light adjustment control signal including white balance information.

13. A video display method in a video display apparatus that changes an image on a light valve in accordance with an input image signal and changes a quantity of light to be incident on the light valve by a light adjusting device, the video display method comprising:
reading an image signal and a light adjustment control signal that controls the light adjusting device from a video recording medium; and
when reproducing the image signal, controlling a quantity of light by the light adjusting device synchronously with the image signal to be reproduced, on a basis of the light adjustment control signal.

14. The video display method as claimed in claim 13, the light adjustment control signal including white balance information, and that after color information of light source at recording representing a color of light source at a time of recording the video is acquired on a basis of the white balance information, correction light source information that cancels and corrects the color information of light source at recording to reference color information representing reference color information being calculated, and on a basis of the correction light source information, a quantity of light being controlled by the light adjusting device synchronously with the image signal to be reproduced.

15. The video display method as claimed in claim 13, a medium from which the image signal is read and a medium from which the light adjustment control signal is read being of different types.

16. A video display apparatus that changes an image on a light valve in accordance with an input image signal and changes a quantity of light to be incident on the light valve by a light adjusting device, the video display apparatus comprising:
a unit that reads an image signal and a light adjustment control signal that controls the light adjusting device from a video recording medium; and
a unit that, when reproducing the image signal, controls a quantity of light by the light adjusting device synchronously with the image signal to be reproduced, on a basis of the light adjustment control signal.

17. The video display apparatus as claimed in claim 16, the light adjustment control signal including white balance information, and the unit that controls the quantity by light of the light adjusting device acquiring color information of light source at recording representing the color of light source at the time of recording the video on the basis of the white balance information, then calculates correction light source information that cancels and corrects the color information of light source at recording to reference color information representing reference color information, and controls a quantity of light synchronously by the light adjusting device with the image signal to be reproduced, on a basis of the correction light source information.

18. The video display apparatus as claimed in claim 16, a medium from which the image signal is read and a medium from which the light adjustment control signal is read being of different types.
